(19) United States
(12) Patent Application Publication
(10) Pub. No.: US 2024/0118100 A1
(43) Pub. Date: Apr. 11, 2024

(54) INFORMATION PROCESSING APPARATUS

(71) Applicant: TOYOTA JIDOSHA KABUSHIKI KAISHA, Aichi-ken (JP)

(72) Inventor: Ai MIYATA, Sakai-shi (JP)

(21) Appl. No.: 18/476,321

(22) Filed: Sep. 28, 2023

(30) Foreign Application Priority Data
Oct. 6, 2022 (JP) 2022-161961

(51) Int. Cl. G01C 21/34; B60L 58/13; B60W 50/14; G06Q 10/02

(52) U.S. Cl. CPC G01C 21/3469; B60L 58/13; B60W 50/14; G06Q 10/02; B60L 2250/16; B60L 2250/30; B60L 2260/52; B60W 2050/146; B60W 2510/244

(57) ABSTRACT

A controller outputs a notification that supply is necessary for a vehicle based on information on a travelable distance of the vehicle and information on a distance from the vehicle to a supply station.

### CROSS REFERENCE TO THE RELATED APPLICATION

This application claims the benefit of Japanese Patent Application No. 2022-161961, filed on Oct. 6, 2022, which is hereby incorporated by reference herein in its entirety.

### BACKGROUND

### Technical Field

The present disclosure relates to an information processing apparatus.

### Description of the Related Art

A navigation device for searching and displaying a charging station is known (see, for example, Patent Document 1).

### CITATION LIST

### Patent Literature

Patent Literature 1: JP 2021-009108

### SUMMARY

The purpose of the present disclosure is to suppress the inability of the vehicle to travel.

One aspect of the present disclosure is directed to an information processing apparatus comprising a controller configured to: output a notification that resupply is necessary for the vehicle based on information on the travelable distance of the vehicle and information on the distance from the vehicle to the supply station.

Further, another aspect of the present disclosure is an information processing method in which a computer executes processing in the information processing apparatus, a program for causing the computer to execute the processing in the information processing apparatus, and a storage medium storing the program in a non-transitory manner.

According to the present disclosure, it is possible to suppress that the vehicle cannot run.

### BRIEF DESCRIPTION OF THE DRAWINGS

FIG. 1 is a diagram showing a schematic configuration of the system according to the embodiment.

FIG. 2 is a diagram showing the relationship between the vehicle and the charging station.

FIG. 3 is a diagram illustrating a functional configuration of a server.

FIG. 4 is a flowchart of processing in the server according to the first embodiment.

FIG. 5 is a flowchart of processing in the server according to the second embodiment.

### DESCRIPTION OF THE EMBODIMENTS

The information processing apparatus according to one aspect of the present disclosure includes a controller. The controller outputs a notification that supply is necessary for the vehicle based on information on the travelable distance of the vehicle and information on the distance from the vehicle to the supply station.

The vehicle is a vehicle that can run using fuel or electric power. The drivable range of the vehicle is the distance that the vehicle can travel without refueling or power. A supply station is a place where fuel or electricity can be replenished, for example, a gas station or a charging station. In the case of a vehicle equipped with an engine, there is a correlation between the amount of fuel refueled in the vehicle and the mileage that can be traveled, and in the case of an electric vehicle, there is a correlation between the remaining battery charge and the mileable distance. Therefore, for example, the travelable distance of the vehicle can be calculated based on the remaining fuel level or the remaining charge of the battery.

Here, if the user of the vehicle does not know the relationship between the travelable distance and the distance to the supply station, the remaining fuel level or the remaining charge amount becomes 0 before the vehicle moves to the supply station, and the vehicle may not be able to run. In particular, since the number of charging stations is still small, it is easy for electric vehicles to become inoperable. Also, when using a car share or rental car, it is possible to overlook the remaining fuel or charge level because it is an unfamiliar vehicle. In addition, in places where there is no land knowledge, it is possible that the user does not know where the supply station is. Therefore, the controller outputs a notification when there is a possibility that the vehicle cannot run. That is, by notifying the user that resupply is required, the vehicle can arrive at the supply station. The notification may be output to the user's terminal or to the vehicle.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

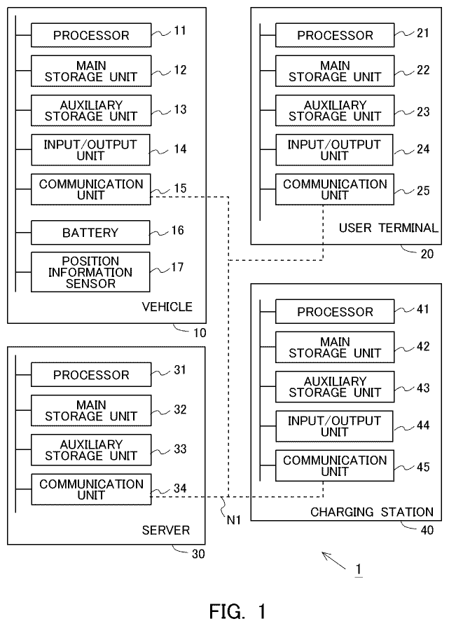

FIG. 1 is a diagram showing a schematic configuration of the system 1 according to the first embodiment. System 1 includes a vehicle 10, a user terminal 20, a server 30, and a charging station 40. System 1 is a system in which the server 30 notifies the user before the charging station 40 ceases to exist from the travelable range of the vehicle 10.

The vehicle 10 is an electric vehicle (Battery Electric Vehicle: BEV). The vehicle 10 may be a vehicle owned by the user, a vehicle used in car sharing, or a rental car. The user is a driver of the vehicle 10 and has a user terminal 20. The charging station 40 is a device capable of charging the battery 16 of the vehicle 10 by supplying power to the vehicle 10. There are a plurality of charging stations 40.

The server 30 notifies the user at a timing when the distance obtained by subtracting a predetermined distance from the travelable distance of the vehicle 10 is equal to or smaller than the distance to the nearest charging station 40 based on the position of the vehicle 10, the remaining charge amount of the battery 16 of the vehicle 10, and the position of each charging station 40. In other words, the user is notified at the timing when the “the travelable distance—the predetermined distance the distance to the nearest charging station” is satisfied. Thereby, it is possible to suppress that the vehicle 10 cannot move to the charging station 40. The predetermined distance is a distance corresponding to the margin when the vehicle 10 moves to the nearest charging station 40. Here, the travelable distance is estimated based on the remaining charge amount of the battery 16. However, since the distance that the vehicle 10 can actually travel may change depending on, for example, the usage status of the air conditioner or the like or the road condition (for example, the slope of a slope), the user is notified with a certain margin. The predetermined distance may be determined by the user. In this case, the user may input a predetermined distance to the input/output unit 24 of the user terminal 20 or the input/output unit 14 of the vehicle 10, and this information may be transmitted to the server 30. Further, the predetermined distance may be 0. As a method for calculating the travelable distance, a known method may be used.

In the present embodiment, an example in which the vehicle 10 is the BEV and charging is performed at the charging station 40 will be described, but not limited to this, it can also be applied when a fuel such as gasoline is refueled at a gas station.

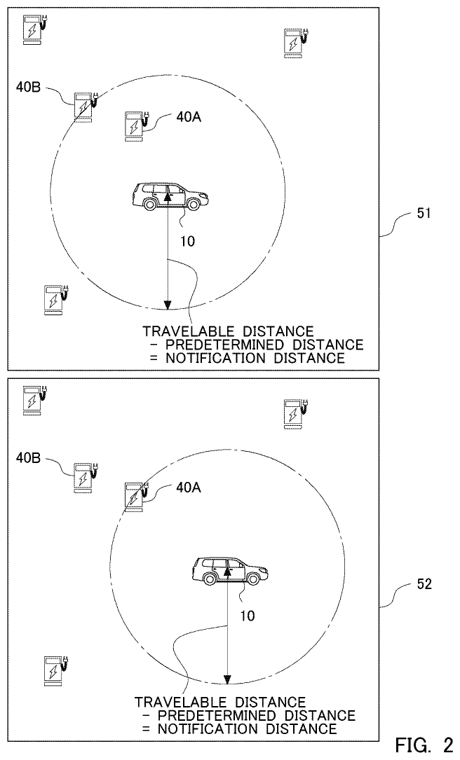

FIG. 2 is a diagram showing the relationship between the vehicle 10 and the charging station 40. The circle of the dash-dotted line centered on the vehicle 10 is a distance from the vehicle 10, and indicates a distance obtained by subtracting a predetermined distance from the travelable distance. Hereinafter, the distance obtained by subtracting a predetermined distance from the travelable distance is also referred to as a notification distance. In FIG. 2, reference numeral 51 indicates that two charging stations (the first charging station 40A and the second charging station 40B) exist within the notification distance from the vehicle 10. When the vehicle 10 moves in the right direction of FIG. 2, the second charging station 40B is first removed from the notification distance. Next, reference numeral 52 indicates that the charging station 40 is only the first charging station 40A within the notification distance from the vehicle 10, and the distance from the vehicle 10 to the first charging station 40A is equal to the notification distance. Using such a state as a trigger, a charging notification is transmitted to the vehicle 10 or the user terminal 20. That is, the charging notification is transmitted at the timing when “the notification distance the distance to the nearest charging station” is satisfied. The charging notification is a notification for prompting the user to charge. The charging notification may include a notification for notifying the user that the charging station 40 no longer exists within the drivable distance of the vehicle 10. The charging notification may be transmitted to the user terminal 20 or to the vehicle 10. The vehicle 10 or the user terminal 20 that has received the charging notification displays, for example, a screen or provides voice guidance that charging is required. Thereby, the user can recognize that charging is required.

The vehicle 10, the user terminal 20, the server 30, and the charging station 40 are connected to each other by the network N1. The network N1 is, for example, a worldwide public communication network such as the Internet, and a WAN (Wide Area Network) or other communication network may be adopted. Further, the network N1 may include a telephone communication network such as a mobile phone or a wireless communication network such as Wi-Fi (registered trademark).

The server 30 has a computer configuration. The server 30 includes a processor 31, a main storage unit 32, an auxiliary storage unit 33, and a communication unit 34. They are connected to each other by buses. Processor 31 is an example of a controller.

The processor 31 includes a CPU (Central Processing Unit) or a DSP (Digital Signal Processor). The processor 31 controls the server 30 and performs various information processing calculations. The main storage unit 32 is RAM (Random Access Memory), ROM (Read Only Memory), and the like. The auxiliary storage unit 33 is an EPROM (Erasable Programmable ROM), a hard disk drive (HDD, Hard Disk Drive), a removable media, and the like. The auxiliary storage unit 33 stores an operating system (Operating System: OS), various programs, various tables, and the like. The processor 31 loads the program stored in the auxiliary storage unit 33 into the work area of the main storage unit 32 and executes it, and each component and the like are controlled through the execution of this program. Thereby, the server 30 realizes a function that matches a predetermined purpose. The main storage unit 32 and the auxiliary storage unit 33 are computer readable recording medium.

The communication unit 34 is a means for communicating with the vehicle 10, the user terminal 20, and the charging station 40 via the network N1. The communication unit 34 is, for example, a LAN (Local Area Network) interface board and a wireless communication circuit for wireless communication. The LAN interface board and the wireless communication circuit are connected to the network N1.

The vehicle 10 includes a processor 11, a main storage unit 12, an auxiliary storage unit 13, an input/output unit 14, a communication unit 15, a battery 16, and a position information sensor 17. These components are interconnected by a CAN bus, which is a bus of the in-vehicle network. Since the processor 11, the main storage unit 12, and the auxiliary storage unit 13 are the same as the processor 31, the main storage unit 32, and the auxiliary storage unit 33 of the server 30, description thereof will be omitted.

The input/output unit 14 is a unit that receives input operations performed by the user and presents information to the user. In the present embodiment, it consists of one touch panel display. The input/output unit 14 may include an input device such as a mouse, a keyboard, a push button, and a microphone, for example. Further, the input/output unit 14 may include an output device such as an LCD (Liquid Crystal Display), an EL (Electroluminescence) panel, and a speaker, for example.

The communication unit 15 is a communication means for connecting the vehicle 10 to the network N1. The communication unit 15 is, for example, a circuit that communicates with other devices (e.g., the server 30 and the like) via the network N1 by making use of a mobile communication service (for example, a telephone communication network such as 6G (6th Generation), 5G (5th Generation), 4G (4th Generation), 3G (3rd Generation), LTE (Long Term Evolution)) or a wireless communication network such as Wi-Fi (registered trademark), Bluetooth (registered trademark), NFC (Near Field Communication), UWB (Ultra Wideband) or the like.

The battery 16 is a secondary battery that can be repeatedly charged and discharged, and can supply power to an electric motor that drives the vehicle 10. The position information sensor 17 acquires the position information (for example, latitude, longitude) of the vehicle 10 at a predetermined period. The position information sensor 17 is, for example, a GPS (Global Positioning System) receiving unit, a wireless communication unit, and the like.

The user terminal 20 is, for example, a small computer such as a smartphone, a mobile phone, a tablet terminal, a personal information terminal, a wearable computer (smart watch, etc.), and a personal computer (PC). The user terminal 20 includes a processor 21, a main storage unit 22, an auxiliary storage unit 23, an input/output unit 24, and a communication unit 25. Since the processor 21, the main storage unit 22, and the auxiliary storage unit 23 are the same as the processor 31, the main storage unit 32, and the auxiliary storage unit 33 of the server 30, description thereof will be omitted. Since the input/output unit 24 and the communication unit 25 are the same as the input/output unit 14 and the communication unit 15 of the vehicle 10, description thereof will be omitted.

The charging station 40 includes a processor 41, a main storage unit 42, an auxiliary storage unit 43, an input/output unit 44, and a communication unit 45. Since the processor 41, the main storage unit 42, and the auxiliary storage unit 43 are the same as the processor 31, the main storage unit 32, and the auxiliary storage unit 33 of the server 30, description thereof will be omitted. Since the input/output unit 44 and the communication unit 45 are the same as the input/output unit 14 and the communication unit 15 of the vehicle 10, description thereof will be omitted.

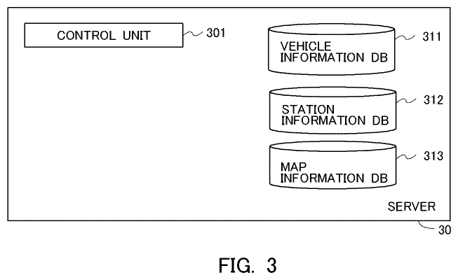

Next, the functions of the server 30 will be described. FIG. 3 is a diagram illustrating a functional configuration of the server 30. The server 30 includes a control unit 301, a vehicle information DB 311, a station information DB 312, and a map information DB 313 as functional components. The processor 31 of the server 30 executes the processing of the control unit 301 by a computer program on the main storage unit 32. The vehicle information DB 311, the station information DB 312, and the map information DB 313 are, for example, relational databases that are built by a program of a database management system (DBMS) executed by the processor 31 to manage data stored in the auxiliary storage unit 33.

The control unit 301 communicates with the vehicle 10, collects information on the vehicle 10 (hereinafter, also referred to as vehicle information), and stores the information on the vehicle 10 in the vehicle information DB 311. The vehicle information includes information on the remaining charge amount of the battery (hereinafter, also referred to as SOC) and position information. The position information is information about the current position of the vehicle 10 detected by the position information sensor 17 of the vehicle 10. The information on the SOC is information about the remaining charge of the battery 16 detected in the vehicle 10. The position information and information about the SOC is transmitted from the vehicle 10 to the server 30 at predetermined intervals.

The control unit 301 communicates with the vehicle 10 or the user terminal 20, collects information on a search target of the charging station 40, and stores the information in the vehicle information DB 311. Information on the search target may be included in the above vehicle information. Information on the search target is information on the conditions of the charging station 40 to be searched when the charging station 40 corresponding to the vehicle 10 is searched. Here, some of the charging stations 40 are compatible with quick charging, and the charging time can be shortened by using this quick charging. Therefore, it is conceivable that the user may wish to use only the charging station 40 that supports quick charging. In such a case, only the charging station 40 corresponding to fast charging is included in the search target.

Further, if the charging station 40 is in use by another user, a waiting time may occur. Therefore, it may be considered that the user wishes to use only the vacant charging station 40. In such a case, only the vacant charging station 40 is included in the search target. Further, the charging station 40 includes one that can be used free of charge and one that can be used for a fee. It is also conceivable that the user wishes to use only the charging station 40 that can be used for free. In such a case, only the charging station 40 that is available for free is included in the search target.

Further, even if the charging station 40 can be used, there is also a charging station 40 located in a direction different from the traveling direction. For example, if the nearest charging stations 40 are located in the opposite direction of travel, the user will have to return the way he came. Therefore, it is conceivable that the user desires to use the charging station 40 present in the traveling direction only. In such a case, only the charging station 40 located in the traveling direction of the vehicle 10 is included in the search target. Further, it is conceivable that the voltage of the charging station 40 does not correspond to the vehicle 10. Therefore, only the charging station 40 that can be charged at a voltage corresponding to the vehicle 10 is included in the search target.

The information on the search target includes, as described above, information on a user's request, such as whether or not to limit the charging station 40 that can be fast-charged, whether or not to limit the charging station 40 that is not in use, whether or not to limit the charging station 40 that can be used for free, whether or not to limit the charging station 40 that exists in the traveling direction of the vehicle 10, and information on a standard or specification such as limiting the charging station 40 in which the voltage of the charging station 40 corresponds to the vehicle 10. Information on the search target is generated, for example, based on the contents input by the user in the input/output unit 14 of the vehicle 10 or the input/output unit 24 of the user terminal 20, and transmitted to the server 30.

The vehicle information DB 311 stores information about the location, SOC, and each of the search targets corresponding to each vehicle 10.

Further, the station information DB 312 stores information (hereinafter, also referred to as charging station information) on the position, usage status, reservation status, whether or not fast charging is supported, whether or not it is freely available, and the voltage corresponding to each charging station 40. The position information of each charging station 40 is information about the position where each charging station 40 is installed, and is registered, for example, by the administrator of the charging station 40. The usage information is information that can be determined whether or not the charging station 40 is being used at this time, and is transmitted from the charging station 40 to the server 30 at predetermined intervals. The information about the reservation status is information about the reserved time of the charging station 40. Reservation of the charging station 40 can be made, for example, from the vehicle 10 or the user terminal 20. The reservation is accepted by the control unit 301 and the station information DB 312 is updated. Whether or not it supports quick charging and whether or not it can be used free of charge is registered on the server 30 by, for example, the administrator of the charging station 40. Information related to the voltage is information about the corresponding voltage at the time of charging, and is registered, for example, by the administrator of the charging station 40 to the server 30.

The map information DB 313 stores, for example, link data related to a road (link), node data related to node points, intersection data related to each intersection, search data for searching routes, search data for searching points, and the like as map information.

Further, the control unit 301 calculates the travelable distance based on the SOC of the vehicle 10. Since the travelable distance is correlated with the SOC, for example, a calculation formula or map for calculating the travelable distance from the SOC is stored in the auxiliary storage unit 33. Further, the control unit 301 calculates the notification distance by subtracting a predetermined distance from the travelable distance. Information on a predetermined distance may be transmitted from the vehicle 10 or the user terminal 20 and may be input by the administrator of the server 30. The control unit 301 searches the nearest charging station 40 from the vehicle 10. The nearest charging station 40 is the nearest charging station from the vehicle 10 among the charging stations matching the search target. Then, when the distance from the vehicle 10 to the nearest charging station 40 is greater than or equal to the notification distance, the control unit 301 transmits a charging notification to the vehicle 10 or the user terminal 20.

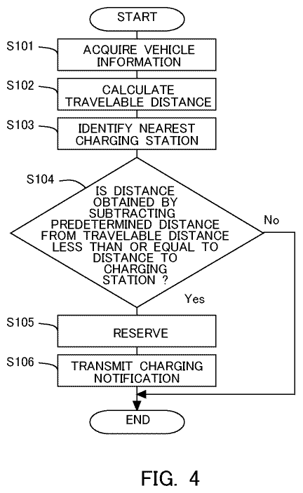

FIG. 4 is a flowchart of processing at the server 30 according to the first embodiment. The process shown in FIG. 4 is executed at predetermined times for each vehicle 10 at the server 30. The vehicle information DB 311 and the station information DB 312 will be described as storing necessary information.

In step S101, the control unit 301 acquires vehicle information. Since the vehicle information is stored in the vehicle information DB 311, the control unit 301 acquires the latest vehicle information corresponding to the vehicle 10 from the vehicle information DB 311. In step S102, the control unit 301 calculates the travelable distance of the vehicle 10. The control unit 301 calculates the travelable distance by substituting the SOC included in the vehicle information into the calculation formula stored in the auxiliary storage unit 33.

In step S103, the control unit 301 identifies the nearest charging station 40. Based on the vehicle information and the charging station information, the control unit 301 identifies the charging station 40 that is closest to the distance from the vehicle 10 among the charging stations 40 that match the search target. For example, if the charging station 40 is in use by another user but allows the user to wait, it is included in the search. On the other hand, if the charging station 40 is in use by another user and the reservation is still full thereafter, the charging station 40 cannot be used even if the user is waiting, so it is excluded from the search.

Then, in step S104, the control unit 301 determines whether or not the distance obtained by subtracting a predetermined distance from the travelable distance calculated in step S102 is less than or equal to the distance to the charging station 40 specified in step S103. That is, the control unit 301 determines whether or not the distance to the nearest charging station 40 is greater than or equal to the notification distance. The predetermined distance is stored in the auxiliary storage unit 33. If it is affirmed in step S104, the control unit 301 reserves the charging station 40 in step S105. If the vehicle 10 does not go to the specified charging station 40 and charge it, the vehicle 10 may not be able to run, so the user is likely to go to the charging station 40. Therefore, the control unit 301 reserves the charging station 40. That is, the control unit 301 updates information on the reservation status of the station information DB 312. This reservation is not mandatory. Therefore, the process in step S105 can be omitted. On the other hand, if it is determined to be negative in step S104, this routine is terminated.

In step S106, the control unit 301 transmits a charging notification to the vehicle 10 or the user terminal 20. The charging notification may include a command to output to the input/output unit 14 of the vehicle 10 or the input/output unit 24 of the user terminal 20 that the remaining battery capacity will be insufficient without charging and the location of the nearest charging station 40. This command may be a command to display a screen on the display, or a command to stream audio from a speaker. The command may also include a command to have the input/output unit 14 of the vehicle 10 or the input/output unit 24 of the user terminal 20 output a statement indicating that the charging station 40 has been reserved. In addition, the command may include a command to display the route to the charging station 40 on the input/output unit 14 of the vehicle 10 or the input/output unit 24 of the user terminal 20.

As described above, according to the present embodiment, since a charging notification is transmitted to the vehicle 10 at a timing when the charging station 40 ceases to exist within the notification distance, the user can be made aware of the need for charging.

### Second Embodiment

In the first embodiment, a charging notification is transmitted based on the distance to the nearest charging station 40, but in the second embodiment, a charging notification is transmitted at a timing when the number of charging stations 40 existing within the notification distance becomes less than a predetermined number. In this case, the server 30 does not know which charging station 40 the user will go to, so the server 30 may inquire of the user which charging station 40 the user will go to, and the server 30 may reserve the charging station 40 according to the user's response.

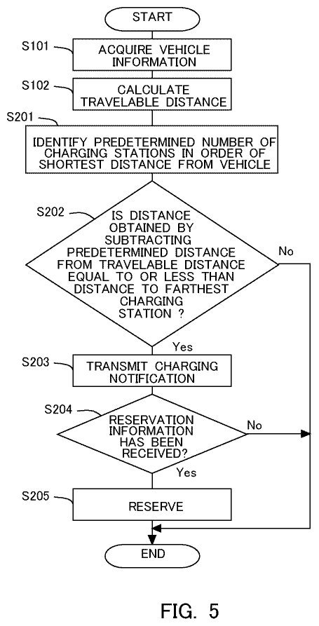

FIG. 5 is a flowchart of processing at the server 30 according to the second embodiment. The process shown in FIG. 5 is executed at predetermined times for each vehicle 10 at the server 30. Steps in which the same processing is performed as in the routine shown in FIG. 4 will be omitted, with the same symbols and explanations

In the flowchart shown in FIG. 5, the process proceeds to step S201 when the process of step S102 is completed. In step S201, control unit 301 identifies a predetermined number of charging stations 40 in order of shortest distance from vehicle 10. Based on the vehicle information and the charging station information, the control unit 301 identifies the charging stations 40 that match the search target in order from the charging stations 40 that are closest in distance from the vehicle 10. The predetermined number may be specified by the user using the user terminal 20 or the vehicle 10, for example, or may be specified by the administrator of the server 30.

In step S202, the control unit 301 determines whether or not the distance obtained by subtracting a predetermined distance from the travelable distance calculated in step S102 is equal to or less than the distance to the farthest charging station 40 among the charging stations 40 specified in step S201. That is, the control unit 301 determines whether or not the distance to the farthest charging station 40 is greater than or equal to the notification distance. If it is affirmative in step S202, the process proceeds to step S203, and if it is determined negative, this routine is terminated.

In step S203, the control unit 301 transmits the charging notification to the vehicle 10 or the user terminal 20. The notification may include a command to output to the input/output unit 14 of the vehicle 10 or the input/output unit 24 of the user terminal 20 that the remaining battery capacity will be insufficient without charging and the location of the charging station 40 to which the vehicle 10 can travel. Further, the charging notification may include an inquiry about whether or not to reserve the charging station 40. For example, the control unit 301 displays the charging station 40 specified in step S201 on the screen of the input/output unit 14 of the vehicle 10, and acquires the charging station 40 tapped by the user from there. The charging station 40 to be reserved is acquired in the vehicle 10. Then, information about the charging station 40 to be reserved is transmitted from the vehicle 10 to the server 30. The user may select the charging station 40 to be reserved by voice.

In step S204, the control unit 301 determines whether or not reservation information has been received from the vehicle 10 or the user terminal 20. The reservation information is information about the charging station 40 to be reserved, and is information transmitted from the vehicle 10 or the user terminal 20. If it is affirmed in step S204, the control unit 301 proceeds to step S205 and reserves the charging station 40 specified by the user. On the other hand, if it is determined to be negative in step S204, this routine is terminated without making a reservation for the charging station 40.

As explained above, according to this embodiment, a notification is sent to the vehicle 10 at the timing when a predetermined number of charging stations 40 are no longer present within the notification distance, it is possible to make the user aware of the necessity of charging. In addition, the user is notified when there are a predetermined number of 40 charging stations remaining to which the vehicle 10 can travel, which gives the user more options. Thereby, user convenience can be improved.

### OTHER EMBODIMENTS

The above-described embodiment and modification are merely examples, but the present disclosure can be implemented with appropriate modifications without departing from the spirit thereof.

The processing and/or means (devices, units, parts, etc.) described in the present disclosure can be freely combined and implemented as long as no technical contradiction occurs.

In addition, the processing described as being performed by a single device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner. For example, a part of the functions of the server 30 may be provided by the vehicle 10 or the user terminal 20.

In the above embodiment, the vehicle 10 used for car sharing and the like has been described, but it is applicable not limited to this and can be applied to a moving body that moves by receiving power supply from a battery. For example, it can be applied to electric kickboards or electric bicycles.

Further, in the above embodiment, the charging notification is transmitted only once, but not limited to this, for example, a plurality of charging notifications can be transmitted by changing the search conditions. For example, the notification may be output at a timing when the nearest charging station 40 that can support fast charging is no longer present within the notification distance, and then the second notification may be output at a timing when the nearest charging station 40 that supports normal charging is no longer present within the notification distance. Further, for example, the notification may be output at a timing when the nearest charging station 40 available for free is no longer present within the notification distance, and then the second notification may be output at a timing when the nearest charging station 40 available for a fee is no longer present within the notification distance.

The present disclosure can also be realized by supplying to a computer a computer program in which the functions described in the above-described embodiment or modification are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus comprising a controller configured to:
output a notification that supply is necessary for a vehicle based on information on a travelable distance of the vehicle and information on a distance from the vehicle to a supply station.

2. The information processing apparatus according to claim 1, wherein the vehicle is an electric vehicle with a battery;
the supply station is a charging station that supplies power to the battery; and
the controller outputs the notification in response to a fact that the distance obtained by subtracting a predetermined distance from the travelable distance of the vehicle becomes less than or equal to a distance from the vehicle to a first charging station.

3. The information processing apparatus according to claim 2, wherein
the controller acquires information on the predetermined distance from a terminal of a user of the vehicle or the vehicle.

4. The information processing apparatus according to claim 2, wherein
the first charging station is a nearest charging station from the vehicle,

5. The information processing apparatus according to claim 4, wherein the controller is configured to:
acquire information on a usage status of a plurality of the charging stations;
identify the first charging station from among available charging stations; and
reserve the first charging station.
